(19) United States
(12) Patent Application Publication
(10) Pub. No.: US 2002/0077151 A1
(43) Pub. Date: Jun. 20, 2002

(54) Polymorphic cellular network architecture

(76) Inventors: Gary Matthews, Satellite Beach, FL (US); Laurence D' Agati, Melbourne, FL (US); Donald Chaffee, Satellite Beach, FL (US)

Correspondence Address: Thomas A. O'Rourke, Wyatt, Gerber & O'Rourke, 99 Park Avenue, New York, NY, 10016, US

(21) Appl. No.: 09/739,351

(22) Filed: Dec. 18, 2000

(51) Int. Cl. H04Q 7/20

(52) U.S. Cl. 455/561; 455/446; 455/449; 455/11.1

(57) ABSTRACT

A nanoCell base station is disclosed for providing radio connectivity among one or more mobile stations, one or more base transceiver stations or one or more other nanoCell base stations. The nanoCell base station of the present invention has one or more transceivers. One of the transceivers provides a base station function, and one of the transceivers provides a mobile station function. A controller is present for managing the transceivers, and determining the communications connectivity paths between base station and mobile station functions.

### FIELD OF THE INVENTION

The present invention relates to improvements in the field of wireless communication, more particularly, the use of nanoCell base stations to increase the capacity of wireless networks by employing and facilitating an improved multifaceted dynamically reconfigurable network topology.

The invention further comprises a method of intercommunication among all nodes of a network to efficiently transport a variety of communications channels.

### BACKGROUND OF THE INVENTION

Due to limitations in the amount of bandwidth available, the cost, both economic and political, of building infrastructure and other reasons traditional cellular communications networks use a variety of geometric topologies to segment a coverage area into cells that facilitate efficient frequency reuse. Each cell typically contains a central antenna, and overlaps slightly with adjacent cells. Most common cellular coverage models use hexagonal or circular footprints, elongated directional coverage zones, sectored regions emanating from a central point, and combinations thereof. A patchwork of geometric coverage zones are pieced together to provide sufficient coverage for the subscriber base, and end-to-end communications is accomplished via a mobile network.

These networks are hierarchical in nature in the sense that end-to-end communications paths are supported by a fan-out from various points of aggregation. The physical channels that carry the communications tend to be fixed, but configurable. Most mobile network topologies, such as GSMMAP or ANSI-41, include a Base Station Subsystem and a Network Subsystem. In the case of GSM, base transceiver station (BTS) hardware is deployed in connection with each antenna to communicate with a plurality of mobile stations (MS) in that cell at any given time. Base Station Controller (BSC) equipment is deployed in such a manner that one BSC will control and communicate with a plurality of BTSs. Likewise, a Mobile Switching Center (MSC) will control and communicate with a number of BSC's. In this manner, the communications path from the fixed network to a plurality of mobile users is easily defined and controlled. A mobile packet data network is configured in a similar manner. Typically, the BSC interfaces to a packet data network support node that provides access to a public data network. In the case of GSM, the Serving GPRS Support Node (SGSN) provides this connectivity between the Base Station Subsystem (BSS) and the Gateway GPRS Support Node (GGSN), which in turn interfaces to the Public Data Network (PDN). Similarities exist in the ANSI-41 mobile network architecture.

The transmit power, and the communication protocol generally define the size of each cell and how many users each cell can support. Other factors that may influence cellular design and the amount of deployed hardware include the number of mobile stations to be serviced in a given area, the operational power levels of the mobile stations and base stations, and the presence or absence of impairments such as terrain, buildings, radio interference, etc. Other factors include communications data rates and the requisite link performance to attain those rates. When planning a cellular network, the amount of deployed hardware in a given region, which will typically include BTS, BSC and MSC equipment, will normally be designed so that there is sufficient capacity to provide adequate coverage and availability during periods of peak traffic loading. Because traffic density will vary throughout the day, and across coverage regions, there is inherent unused capacity within a cellular network available for use at any given time. The invention makes use of the excess capacity within a cellular network to redistribute traffic to underutilized aggregation points to increase overall network capacity without the cost and political issues raised by the construction of new infrastructure.

In order to obtain adequate radio coverage of a geographical area, a plurality of base stations are normally required. Each cell may either be serviced by its own base station or may share a base station with a number of other cells. Each cell has an associated control channel over which control (non-voice) information is communicated between the mobile station in that cell and the base transceiver station. Generally, the control channel includes a dedicated channel at a known frequency over which certain information is communicated from the base transceiver station to mobile stations, a paging channel for unidirectional transmissions of information from the base station to the mobile station, and an access channel for bi-directional communications between the mobile stations and the base station. These various channels may share the same frequency, or they may operate at different respective frequencies.

In addition to control channels, each cell may be assigned a predetermined number of traffic channels for communicating the content of a communication between subscribers. That content may be analog or digitized voice signals or digital data signals. Depending on the access mode of the cellular system, each voice channel may correspond to a separate frequency in Frequency Division Multiple Access (FDMA), a separate frequency and time slot or slots in Time Division Multiple Access (TDMA), or a separate code in Code Division Multiple Access (CDMA). The present invention may be implemented using any of these multiple access techniques or such other techniques as may be developed in the future.

In a frequency division multiple access (FDMA) system, a communications channel consists of an assigned frequency and bandwidth (carrier). If a carrier is in use in a given cell, it can only be reused in other cells sufficiently separated from the given cell so that the other cell signals do not significantly interfere with the carrier in the given cell. The determination of how far away reuse cells must be and of what constitutes significant interference are implementation-specific details readily ascertainable to those skilled in the art.

In a time division multiple access (TDMA) system, time is divided into time slots of a specified duration. Time slots are grouped into frames, and the homologous time slots in each frame are assigned to the same channel. It is common practice to refer to the set of homologous time slots over all frames as a time slot. Typically, each logical channel is assigned a time slot or slots on a common carrier band. The radio transmissions carrying the communications over each logical channel are thus discontinuous in time.

One example of a TDMA system is a GSM system. In GSM systems, in addition to traffic channels, there are four different classes of control channels, namely, broadcast channels, common control channels, dedicated control channels, and associated control channels that are used in connection with access processing and user registration.

In a code division multiple access (CDMA) system, the RF transmissions are forward channel communications and reverse channel communications that are spread over a wide spectrum (spread spectrum) with unique spreading codes. The RF receptions in such a system distinguish the emissions of a particular transmitter from those of many others in the same spectrum by processing the whole occupied spectrum in careful time coincidence. The desired signal in an emission is recovered by de-spreading the signal with a copy of the spreading code in the receiving correlator while all other signals remain fully spread and are not subject to demodulation.

The CDMA forward physical channel transmitted from a base station in a cell site is a forward waveform that includes individual logical channels that are distinguished from each other by their spreading codes (and are not separated in frequency or time as is the case with GSM). The forward waveform includes a pilot channel, a synchronization channel and traffic channels. Timing is critical for proper de-spreading and demodulation of CDMA signals and the mobile users employ the pilot channel to synchronize with the base station so the users can recognize any of the other channels. The synchronization channel contains information needed by mobile users in a CDMA system including the system identification number (SID), access procedures and precise time-of-day information.

In the last few years the increase in wireless communications has been exponential. Cell phones have become ubiquitous and their use has become so common that many jurisdictions are contemplating placing certain restrictions on their use in automobiles, restaurants and other locations. Although most of the growth in wireless technology in recent years has been related to cell phone usage, access to the Internet by wireless communication is a current reality. Where wireless communication systems may require as little as eight kilohertz of bandwidth for voice transmissions, multimedia communications typically require much greater bandwidth. The typical bandwidth desired for digitized packet data transmission for Internet applications continues to increase, where at one time the standard was typically, 28.8 kilobits per second (KBPS), it quickly increased to 33.3 KBPS and is now at the bandwidth limit of 56 KBPS of bandwidth for standard telephone modem access. Heretofore, such bandwidth was achievable only through the use of a wired connection in a wired communication system. Wired modems, operating between 28.8 to 56 KBPS, have generally provided sufficient bandwidth for most Internet users. Alternatively, Integrated Services Digital Network (ISDN) lines used in conjunction with ISDN modems provided relatively greater bandwidth for users. However, such bandwidths were again only attainable in a wired communication system. Until recently, the bandwidth in wireless communications was insufficient to permit more than just relatively short e-mail messages or other short message services to be transmitted and received by wireless. An effort is underway in the wireless data industry to deploy the Wireless Access Protocol (WAP) which provides abbreviated web access for WAP enabled mobile units. Although this is an effort to provide better wireless web access, it requires web page programming over and above the content that would be provided to a higher speed, wired access device. As the public becomes used to the high speeds provided by hard wired systems such as cable and high speed DSL lines, in some cases 1.5 megabits per second (MBPS) or greater, there has been great interest in having the same type of service while away from home or the office. As a result, great interest has been generated in providing more bandwidth to the wireless community to permit Internet access and other data services by wireless technology. Wireless data standards today support data rates from 114 KBPS to at least 2 MBPS. As compared to the requirements for voice transmissions, the requirements for the transfer of multimedia information are great, and there is a significant burden this places on the development of the wireless data infrastructure.

The proliferation of cell phones and other wireless apparatus as well as further increases in wireless data rates that have been projected, have raised serious concerns about the infrastructure to support the use of wireless technology. While the public readily latches onto new types of wireless technology this same public will not permit the operators of the infrastructure to put the necessary antennas and other required equipment in many residential areas. As a result, companies have been presented with a dilemma of providing the service desired by the public over a system that is becoming overloaded and yet there are difficulties in expanding the system in the traditional manner of adding additional base stations. Increasing the number of base stations, while solving some of the infrastructure issues does not remedy the problem completely. In addition to the public's safety and aesthetic concern of adding additional base stations, many providers are seeking other solutions to the problem of overuse of the network. Base station construction is not a panacea to the problem because of the great cost that is required in constructing and maintaining the station. As a result, even in those regions where there is the space to add base stations and the opposition is not strong cost can preclude rapid expansion. Many of the parts of the country that require a growth in service include several underpopulated regions where the cost per user remains relatively high compared to more congested regions. As a result, the industry has been reluctant to expand in these areas until there is a greater population. Unfortunately, the increase in population that renders additional base stations more essential also bring about a reduction of the locations where the base station would be more acceptable. The current invention is intended to be small, easily mounted, and relatively obscure from view, alleviating many of the concerns raised by these residential communities.

Current efforts underway in the wireless industry to increase capacity, data rates and services for a growing subscriber base include increasing spectrum allocations, providing more efficient data modulation schemes, and implementing better frequency reuse schemes. Each of these methods improves upon the problem to varying degrees. Increasing spectrum allocations alone will provide a one to one increase in capacity, that is, in the case where 1 MHz of bandwidth supports 40 voice-grade channels, adding another 1 MHz of spectrum will increase total capacity by 40 additional voice-grade channels. Similarly, increasing spectrum efficiency through higher-order modulation techniques can increase capacity by a one to “n” factor. For example, if 30 kHz of spectrum supports a single voice-grade channels using frequency modulation and by using digital modulation the same 30 kHz channel can support 3 voice-grade channels, the efficiency is increased by a factor of 3, that is, “n”=3.

Generally, increasing modulation efficiency must be traded off against the need for a higher signal to noise ratio (SNR), or carrier to interference ratio (C/I). This implies that more power must be transmitted in the direction of the intended receiver through amplification or directional antennas, and that interference with co-channel or adjacent channel signals must be lower. Achieving these improvements in SNR or C/I performance in a dynamic mobile environment is a costly undertaking.

A technique for exponentially increasing spectrum efficiency, and thus capacity, is to improve frequency reuse. Several techniques are used to accomplish this, including cell sectorization using directional antenna arrays, cell radius reduction techniques, frequency hopping to statistically distribute co-channel induced errors over all channels, etc. It has been shown in the literature that reduction of cell radius will increase frequency reuse by a power of 2, that is, replacement of a large cell by a plurality of smaller cells each of which has a cell radius reduced by a factor of “r” will increase capacity within the area originally covered by the larger cell by a factor of r assuming that all frequencies are reused within each smaller cell. Numerous methods are proposed to reduce cell radius to effect the exponential increase in capacity. The drawback to these techniques is that the supporting infrastructure costs tend to be prohibitively expensive.

Finally, capacity within a cellular network is generally defined in terms of statistical probabilities of a call being blocked. Generally accepted statistics can be used to relate the total number of channels in a network to the supported subscriber base within that network. For example, an offered load (A₀) of 0.03 Erlangs per subscriber with a 2% blocking probability (B) and a capacity of 30 channels (N) per cell translates into a maximum load of 21.9 Erlangs (A′) for that cell, assuming an Erlang B model. For this example, a 30 channel cell can accommodate 21.9/0.03 (A′/A₀)=730 (M) subscribers. The relationship from A′ to N is exponential in the sense that an increase in N more than increases A. Adding equipment to increase the number of channels (N) tends to be expensive with the net effect that in order to support peak load in any given cell at any given time, all cells must increase the number of channels (N) resulting in significantly more underutilized capacity within the overall network. The current invention redistributes load among underutilized base stations, virtually increasing instead of physically increasing “N”, and thus the total number of subscribers is increased within a given area with minimal additional infrastructure cost.

In order for a network of cellular base stations to achieve the significant increase in capacity using the techniques described above, it is assumed that each cell provides a dedicated communications path from the cell to a central switching point, in this case, from the BTS to the BSC. When a multi-cell network is built, each cell will contain the hardware necessary to support the expected busy hour load within its coverage area. At other times or in other areas, the excess capacity in each cell is dormant.

Efforts to solve some of the above-described problems can, themselves, produce requirements beyond the capabilities of present-day cellular systems. For example, one method of increasing the system's traffic capacity is to have a higher degree of radio frequency reuse. (Radio frequency reuse refers to the fact that radio frequencies are assigned for use by particular cells in a manner so as not to interfere with communications in neighboring cells. However, because the number of assignable frequencies would be exhausted before assignments had been made to each cell in the system, the frequencies assigned to one cell are very often also assigned to a more distant cell that is unlikely to cause interference in, or experience interference from, the first cell.) To accomplish greater radio frequency reuse, the physical size of cells is reduced (by reducing the signal strength of radio signals between the BTS and the MS) so as to create what are called micro- and pico-cells. Of course, if the same overall geographical area is to be served by the cellular system, then the use of micro- and pico-cells means that more BTS's are required, thereby requiring a corresponding increase in data and signaling transmission capacity between the BTS's and the rest of the system. As a result of these issues, there has been a need to provide more bandwidth to satisfy the need for an increase in the overall data capacity of the wireless network in a cost efficient, publicly acceptable manner.

### OBJECTS OF THE INVENTION

It is an object of the present invention to provide an increase in the data capacity of a wireless network in a low tier cellular network without the need to increase the number of network base stations.

It is an object of the invention to provide a method, system and apparatus for increasing the data capacity of a wireless network while minimizing capital expenditures and operating expenses per subscriber.

It is also an object of the present invention to provide an architecture that maximizes frequency reuse to increase capacity in a cellular network.

It is a further object of the invention to provide a method, system and apparatus that use “in band” channels for interconnection with other base stations to minimize infrastructure costs.

It is an additional object of the present invention to provide an improved method system and apparatus to maximize frequency allocations, modulation techniques and multiple access methods in a cellular network.

It is further object of the invention to provide a base station that does not always have to be placed on a cell tower.

It is an object of the present invention to provide a system of base stations that is interconnected by in band backhaul.

It is an additional object of the invention to use software designed radio technology in the network to avoid problems due to changes in wireless standards.

It is an objective of the invention to use easily configurable hardware to support increased spectrum allocations. It is also an objective of the invention to operate in a frequency division duplex network using non-traditional means of frequency reuse to increase capacity. That is, an uplink frequency may be used to carry communications traffic as though it were a downlink channel, and vice versa.

It is an objective of the invention to enable cell radius reduction while minimizing the additive infrastructure costs.

### SUMMARY OF THE INVENTION

The nanoCell architecture of the present invention uses dynamically allocated communications paths from the nanoCell to less used network entry points, that is, the communications path from a given nanoCell to a BSC is dynamically altered via a plurality of BTS's in order to achieve increased overall network capacity. This is done in such a way as to minimize total capital and operating expense.

The invention comprises a cellular network element referred to herein as a nanoCell base station and a communication system made of one or more of these nanoCell base stations. Each nanoCell base station provides radio connectivity among a plurality of mobile stations, base transceiver stations, and other nanoCells to provide significantly increased capacity in a given cellular network. Each nanoCell comprises a plurality of transceivers, each of which provides a base station function, a mobile station function, or both a base station and mobile station function. In addition, the nanoCell provides a control function which manages the transceivers, and determines the communications connectivity paths between base station and mobile station functions.

The primary means of connectivity between nanoCells is through radio links which utilize radio frequencies normally reserved for base station to mobile station communications within a cellular network, so called “in-band” backhaul. The purpose of using “in-band” backhaul is to significantly reduce the expense and complexity of traditional communications backhaul, namely microwave, fiber optic cables, wires, or other means. This approach differs from prior art in that the “in-band” backhaul frequencies are dynamically assigned based upon link performance requirements and traffic load requirements and a given nanoCell may communicate directly with one or more base transceiver stations or one or more additional nanoCells. “In-band” backhaul connectivity may be dynamically reconfigured to make efficient use of available frequencies, to provide higher or lower data rates to support data throughput requirements, or transmit at higher or lower power to enhance interference characteristics so that a network may operate more effectively.

The transceivers within a given nanoCell are easily reconfigurable using so called Software Defined Radio concepts and technologies. The reconfigurability of a given transceiver is such that it can be programmed to support multiple simultaneous cellular communications standards, modulation schemes and data rates in order to efficiently convey communications within the cellular network. The transceivers also support a variety of communications standards, including, but not limited to those frequency bands, modulation techniques and multiplexing methods associated with North American cellular, GSM, DCS, PCS, UMTS, and MMDS. In addition, the nanoCell provides a lower-tier wireless distribution capability that can be used in conjunction with other higher tier wired or wireless communication distribution systems including, but not limited to Integrated Services Distribution Network (ISDN), Ethernet, Cable Modems, Digital Subscriber Loops (DSL), Multi-Channel, Multi-Point Distribution System (MMDS), Local Multipoint Distribution System (LMDS), Satellite based communications systems, etc, in which nodes of the aforementioned higher-tier systems are substituted for a BTS in the previous discussion.

The flexibility afforded the nanoCell leads to a number of configurations resulting in a polymorphic cellular network architecture. In its simplest embodiment, the nanoCell may be used as a radio repeater to extend the range or coverage area of a cell. A configuration that provides greater capacity is when the nanoCell supports base station and mobile station functionality. In this way, the nanoCell performs complete demodulation and message decoding of inter-cell communications in order to detect and correct errors induced by the communications channel, provide aggregation of multiple independent channels into a more efficient single channel, and perform dynamic channel allocation and message routing within the grid of nanoCells. Constituent functions of a given nanoCell within the overall architecture include:

RELAY—nanoCell function wherein a single channel is redirected to an alternate channel with minimal latency. Sub-modes include direct frequency translation and amplification, and baseband processing to mitigate channel impairments.

COLLECTOR—nanoCell point of aggregation wherein multiple channels are collected into a common cell and forwarded to another node without conversion. This is a transparent operating mode characterized by constant throughput, constant transit delay and variable error rate.

CONCENTRATOR—nanoCell point of aggregation wherein one or more channels are concentrated into a common cell and converted to a higher data rate channel for transmission efficiency. This is a non-transparent operating mode characterized by improved error rate with variable transit delay and throughput..

DELAY—nanoCell function wherein packets are received and temporarily held in suspension until an appropriate communication channel is available for retransmission of the packets.

A given nanoCell may support one or more of these functions in any combination at any given time. Furthermore, a plurality of nanoCell base stations may be concatenated to form a series of intercommunicating cells which extend the operating distance of a cellular network. In addition, a plurality of nanoCell base stations may be configured into an ad hoc matrix such that redundant parallel communication paths are formed between a plurality of network base stations and a plurality of mobile stations. Likewise, any combination of concatenated nanoCells and nanoCell matrixes may be configured to provide ubiquitous, polymorphic, wireless coverage.

The objects of the present invention are achieved, inter alia, through the use of a system of nanoCell base stations and network base stations, i.e., one or more nanoCell base stations and available network base stations, where the various base stations are interconnected to each other by in band backhaul. The use of in band back haul permits significant increase in the capacity of current infrastructure without unduly increasing the cost of the system. The use of in band backhaul permits the nanoCell base station to utilize network base station resources that are underutilized at any given moment in time to increase overall capacity of the system. By using in band backhaul techniques reliance on microwave, fiber optic or cable backhaul equipment can be reduced, if not eliminated.

Another advantage of the present invention is the inherent redundancy that simplifies logistics support. Since in band backhaul permits auto-configuration of the network, there is an inherent fault tolerance which reduces support costs by minimizing on-call technical support. The system of the present invention can also be maintained by a lower skilled labor force thereby reducing the salary budget for the network.

Another of the advantages of the present invention is the implementation of very small cells to minimize the need for high transmit power. With transmit power reduced in the nanoCell base stations, the need for additional base transceiver stations and the problems attendant their placement is significantly reduced. In addition, with the reduced transmit power equipment design and network planning is also reduced. The very small base stations of the present invention are easier for the system operator to find suitable locations for and in most cases the need to locate them on a cell tower is eliminated.

One area of major improvement over the prior art base stations in the nanoCell base station is in the area of economics. Capital expense can be reduced because the local opposition to the traditional high powered base station should not be a factor. Thus, the costs due to a lengthy planning cycle are reduced and the zoning and regulatory requirements should be eliminated. Land acquisition cost either through purchase or leasing should be reduced. Also, the frequency management and coordination issues associated with microwave backhaul are reduced. There will be lowered installation costs as well as reduced equipment maintenance and acquisition costs. Since the present invention is not as complex as the traditional systems installation costs both of labor and equipment are reduced. The cost benefits do not end with the installation of the present invention. Operating expenses each month are also less through the reduction of leased lines and cell tower real estate.

Because the invention uses a standards based architecture two additional benefits are achieved, there is less cost to recover due to lower equipment acquisition cost and less development risk because the basic communications principles are readily understood.

### BRIEF DESCRIPTION OF THE DRAWINGS

FIG. 1 is a polymorphic cellular network comprising a plurality of nanoCell base stations, base transceiver stations (BTS), with the attendant base station controller (BSC).

FIG. 2 shows the polymorphic cellular network architecture in which nanoCell base stations, functioning as relays, collectors, concentrators, or delay nodes.

FIG. 3 is a representation of the multiple transceiver architecture of a nanoCell base station.

FIG. 4 is a representation of a collector function performed by a nanoCell transceiver.

FIG. 5 is a representation of a concentrator function performed by a nanoCell transceiver.

FIG. 6 is a representation of a relay function performed by a nanoCell transceiver.

FIG. 7 is a representation of a delay function performed by a nanoCell transceiver.

FIG. 8 is a of an alternative frequency use plan where downlink channels are carried on frequencies normally used for uplink channels.

FIG. 9 represents a network routing example.

FIG. 10 represents the hierarchical nature of initial node synchronization.

FIG. 11 represents a general node connectivity pattern.

FIG. 12 represents a hierarchical backhaul structure.

FIG. 13 is a block diagram of a software defined radio in the nanoCell architecture.

FIG. 14 is an alternative embodiment of a software defined radio in the nanoCell architecture.

FIG. 15 represents the elements of a software defined radio.

FIG. 16 is a block diagram of the RF Transceiver.

FIG. 17 is a functional diagram of the baseband processor.

FIG. 18 is an example of a baseband processor implementation.

FIG. 19 represents a steerable antenna configuration connecting multiple nanoCells to a macro cell.

### DETAILED DESCRIPTION OF THE INVENTION

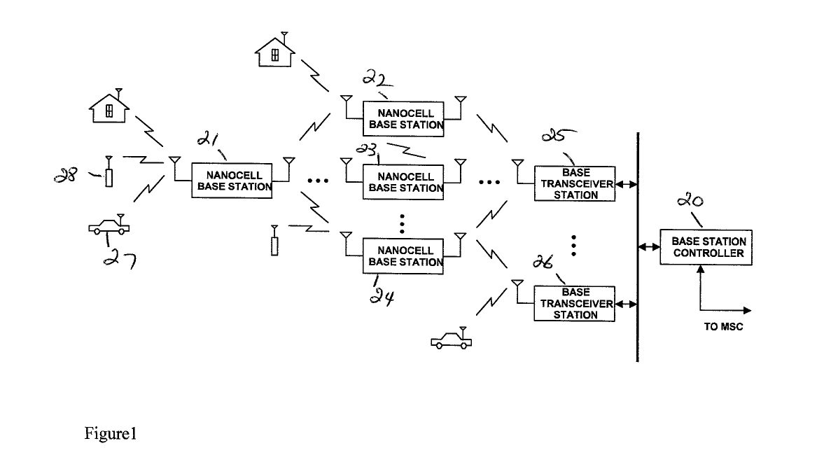

FIG. 1 shows a polymorphic cellular network comprising a plurality of nanoCell base stations 21, 22, 24, 24 base transceiver stations (BTS) 25, 26, with the attendant base station controller (BSC) 20. As seen in the figure, a nanoCell base station 21 may communicate with one or more other nanoCell base stations 22, 23, 24 with one or more primary base stations 25, 26, i.e., macro cell BTS and with one or more mobile stations 27, 28. The communication path from a mobile station to a BTS may be made through one or more intercommunicating nanoCell base stations. As seen in FIG. 1 the presence of a number of nanoCell base stations in a given geographical location reduces and can also eliminate the need for additional macro cell stations. In addition, as seen in FIG. 1 the presence of the nanoCell base stations makes coverage in a given area significantly more uniform thereby reducing the number of dead spots and other areas of weak or spotty coverage.

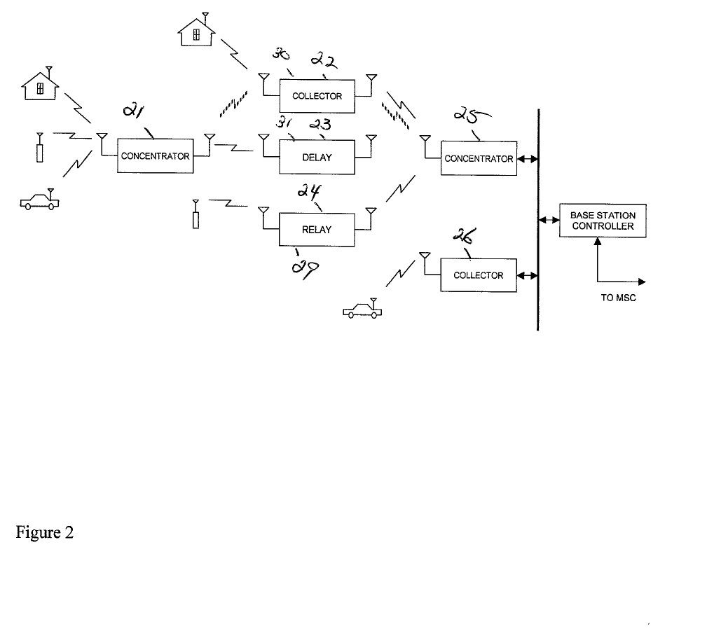

The nanoCell base stations 21, as shown in FIG. 2, function as relays 29, collectors 30, concentrators, or delay nodes 31, as shown in FIG. 2 in order to provide efficient connectivity between mobile and base transceiver stations. The mobile stations may be any wireless communication device including but not limited to cellular telephone, computer, PDA etc. Two or more nanoCell base stations are each networked with one another in their respective areas of operation. In the event that the concentration of traffic is such that there is insufficient capacity between the nanoCell base station 21 and the macro cell BTS 25, the use of in-band back haul in communication with any other nanoCell base station 22 with low traffic concentrations overcomes the lack of bandwidth between nanoCell base station 21 and the macro cell BTS 25.

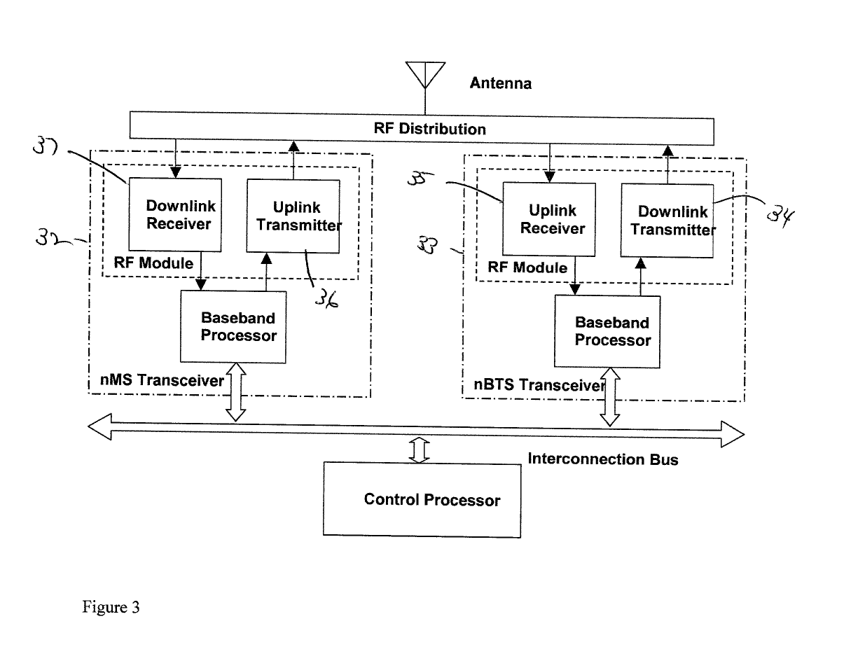

A single nanoCell base station 21, FIG. 3, comprises one or more communication transceivers 32 and 33, each sharing a common control function. The preferred embodiment comprises from two to four transceivers. It is reasonable to implement seven or more transceivers. A communication transceiver may function as a BTS, as a MS or as a relay. When functioning as a BTS 33, the communication transceiver transmits on downlink channels 34 and receives on uplink channels 35, as would a base station. When functioning as a MS 32, the communication transceiver transmits on uplink channels 36 and receives on downlink channels 37 as would a MS. When functioning as a relay, the communication transceiver transmits and receives on independent channels, either of which may be uplink or downlink channels. In the case of the relay function, a channel would be configured as an uplink receiver and uplink transmitter, or conversely, as a downlink receiver and downlink transmitter.

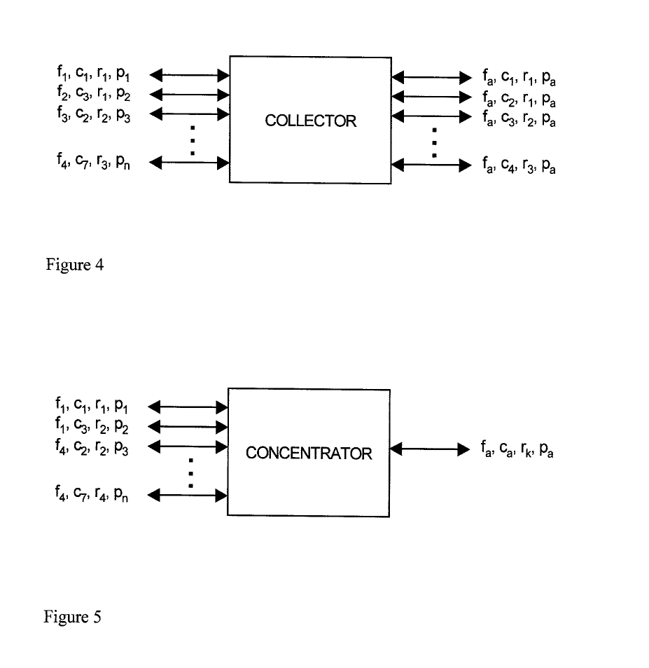

The nanoCell, when functioning as a collector in FIG. 4, reroutes multiple individual channels without modifying the data stream of the incoming/outgoing channel. For a given channel defined by a center frequency (f), a channel identifier (c), a data rate (r), and power level (p), this channel is converted without modification of the data stream to a secondary frequency and channel number that is multiplexed with other individual channels. Power management of the secondary channel is then used to improve overall performance of all individual channels.

As shown in FIG. 4, to clarify, in a TDMA system, the collector function takes bursts related to an individual channel and re-multiplexes these into a new channel, possibly on a different carrier frequency, without modification of the burst structure. In this way, “f”, and “c” are changed without changing “r”. Inherent in this is the ability to readily control the power level of these multiplexed channels to more efficiently convey information. Similarly in a CDMA system, individual code channels are re-multiplexed onto a new channel with similar benefits.

The nanoCell, when functioning as a concentrator in FIG. 5, allows for data rate conversion and concentration of multiple independent channels into a new, higher rate channel. This implies that multiple lower rate channels may be combined into a higher rate channel, thus providing more efficient use of spectrum. This process is bidirectional in that it will also parse a concentrated high rate channel into its constituent lower rate independent channels.

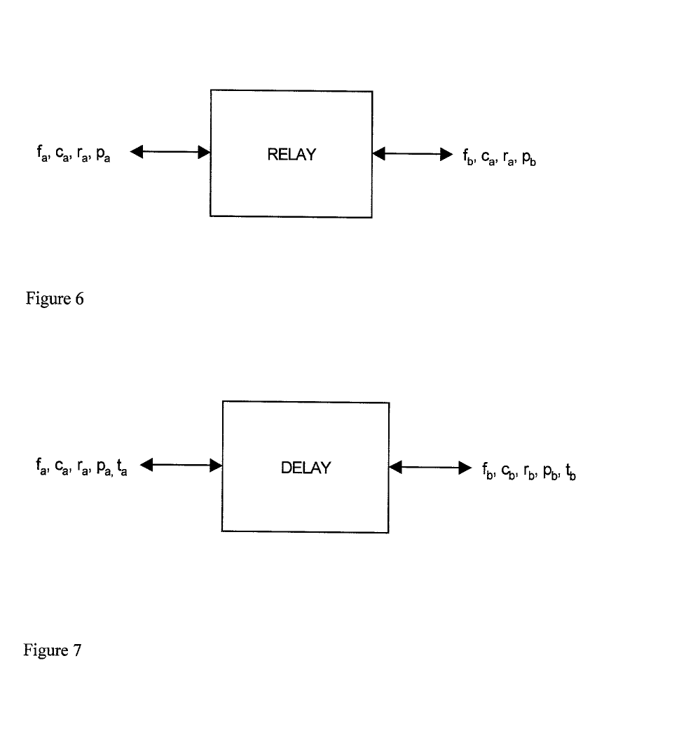

The nanoCell, when functioning as a relay in FIG. 6, translates an individual channel between the incoming and outgoing channels without modification of the data stream or the multiplexing structure. In this way, overall latency within the network is minimized. There is a finite limit to the number of concatenated relays that may exist at a given time due to two-way time delays and the cumulative effect of additive noise in each channel. For this reason, it is necessary to intersperse relays, concentrators and collectors to optimize communications performance.

The nanoCell, when functioning as a delay in FIG. 7, receives and holds data until such time that an appropriate outgoing channel is available. In this way, higher priority communications will receive preference for use of a nanoCell transceiver resource while a lower priority communication is temporarily delayed. The delay may be fixed or variable, and may encompass translation at any level, depending on the subsequently selected output channel. It is reasonable that a nanoCell with multiple transceiver channels may function as each of these simultaneously.

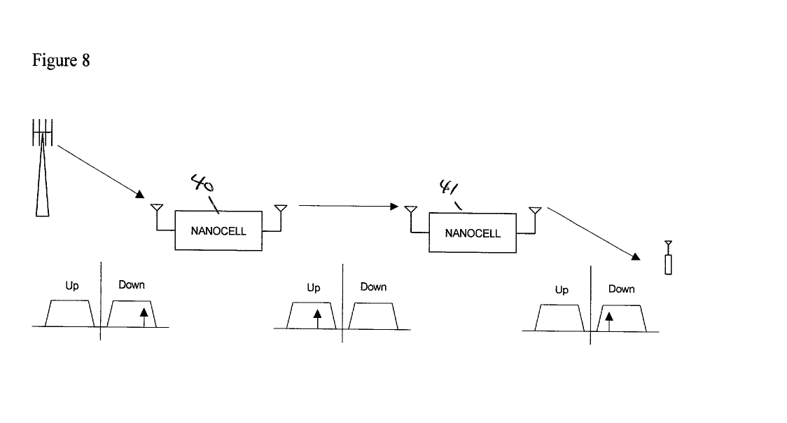

In addition, a communications channel that is predominantly meant to traverse a FDD network from a BTS to a mobile station, that is, via a downlink channel, or conversely from a mobile station to a fixed site, that is, via an uplink channel, may be translated by two or more nanoCells 40 and 41 in a non-standard manner to make most efficient use of underused spectra, as shown in FIG. 8. Such would be the case if the uplink portion of a FDD type network is underutilized due to the fact that uplink data rates tend to be much lower than downlink data rates. In this way, uplink and downlink spectra that are inherently balanced—same amount of spectrum in each direction—may be better utilized to transport asymmetrically loaded data traffic.

The radio network of the present invention provides for capacity expansion through frequency reuse among a preponderance of intercommunicating nanoCell base stations. Communications and control channels are capable of being dynamically allocated from a set of allowed uplink and downlink frequencies, time slots and code channels. Communication paths are dynamically assigned to the appropriate base station based on traffic load, quality of service requirements and intercommunicating base station connectivity constraints.

The control of a nanoCell enables the intercommunication among multiple nanoCells and base stations. This intercommunication allows linkage between adjacent nanoCells without the need to involve a primary base station. By doing so, information to be used in the autonomous network management function is efficiently distributed among nanoCells. This autonomous network routing is unique in that it allows the nanoCell to make autonomous routing decisions instead of a base station controller or mobile switching center, or similar network control functions.

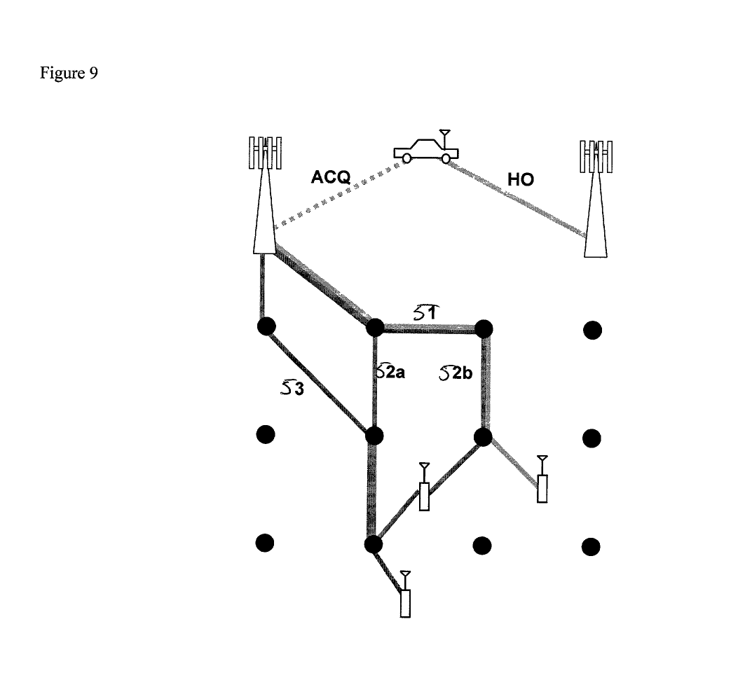

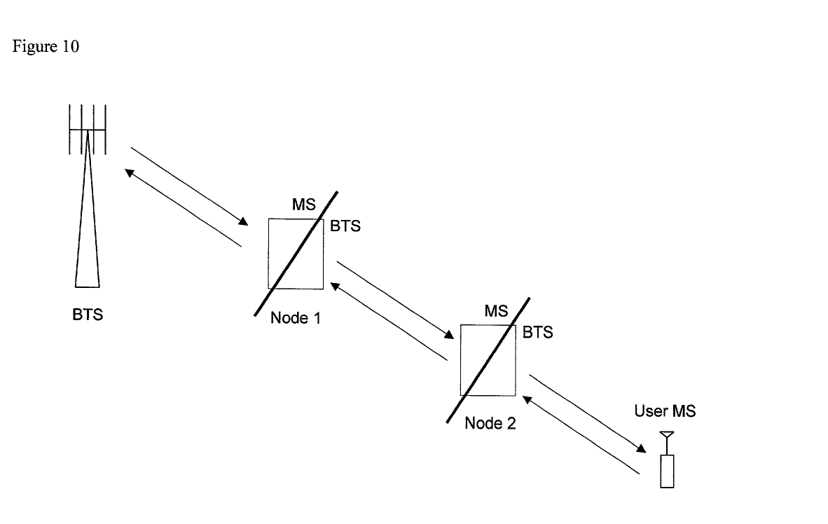

The intercommunicating network of nanoCell base stations dynamically determines efficient communication paths based on service prioritization, network loading and node availability as shown at reference numerals 51 and 53 in FIG. 9. Subsequent communications can be routed via different paths in order to distribute traffic loading as shown at reference numerals 52a and 52b in FIG. 9. Communications within a nanoCell network can be redistributed away from or toward a particular BTS in order to more efficiently accommodate mobile stations with varying quality of service requirements. In the case shown in FIG. 9, a mobile station would acquire BTS 1 (ACQ) and subsequently, a handover (HO) is performed within the infrastructure network to redistribute traffic loads.

The auto-network configuration feature of the present invention allows self discovery within a network thus simplifying deployment. Initialization of a new node is similar to an MS registration within a new network.

FIG. 10 shows the operation of in band backhaul by the present invention. Node 1 synchronizes to the beacon channel and establishes its local frequency and timing reference. Node 1 registers with the BTS as a mobile station (MS). Node 1 subsequently broadcasts as a BTS on an alternative beacon channel. Node 2 synchs to node 1 beacon channel and establishes the frequency and timing reference. Node 2 registers with node 1 as an MS. Node 2 subsequently broadcasts as a BTS on an alternative beacon channel. The user MS synchs to node 2 beacon channel and establishes its local frequency and timing reference. The user MS registers with node 2. Once the user registers with node 2, the user requests service and establishes a circuit or packet connection with node 2. Node 2, node 1 and BTS establish appropriate connections. The BTS establishes the connection with MSC for billing purposes.

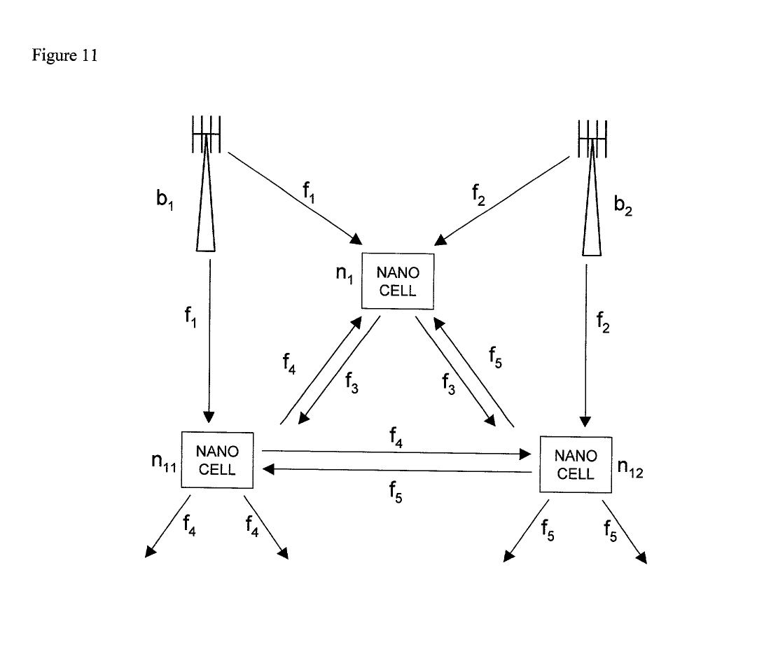

Extending this process of synchronization and channel allocation, a network topology may be derived as shown in FIG. 11. In this figure, a hierarchical topology is derived through MS to BTS synchronization processes. NanoCell n1 receives beacon channel f1 and f2 from BTS b1 and b2, respectively, and synchronizes to each individually. NanoCell n1 then selects beacon channel f3 to transmit. In turn, nanoCells n11 and n12 receive frequencies f1, f2 and f3, and synchronizes to each individually. Subsequently, n11 and n12 select beacon channels f4 and f5 respectively to transmit. There is a mechanism such that if synchronization is established between two nodes, additional synchronization is dismissed. In the case of FIG. 11, n1 will not synchronize to n1 via f4, nor will n12 synchronize to n1 via f5. If by some means, n12 synchronizes to b2 via f2 before it synchronizes to n1 via f3, then it is reasonable that n1 will synchronize to n12 via f5. Likewise, synchronization between n1 and n12 via f4 or f5 will depend on the order in which synchronization occurs. If any link is lost between any two nodes, re-selection of a new beacon channel occurs, and re-synchronization is used to establish new connectivity within the network. In this way, connectivity between nodes within a network structure may be autonomously established and maintained.

One key aspect of the synchronization function is that it allows a nanoCell to establish the requisite accuracy in its internal frequency reference based upon the transmitted accuracy of adjacent nanoCells. Traditional means would use expensive devices such as rubidium or cesium standards, GPS receivers, or other more elaborate schemes (typical accuracy requirements are less than 0.05 parts per million—ppm—for a BTS control channel, while typical mobile stations will synchronize to a BTS and tune their internal references to within 0. 10 ppm. The nanoCell will use a plurality of received control channel signals to calculate the best tuning control to statistically maintain an accuracy of 0.05 ppm

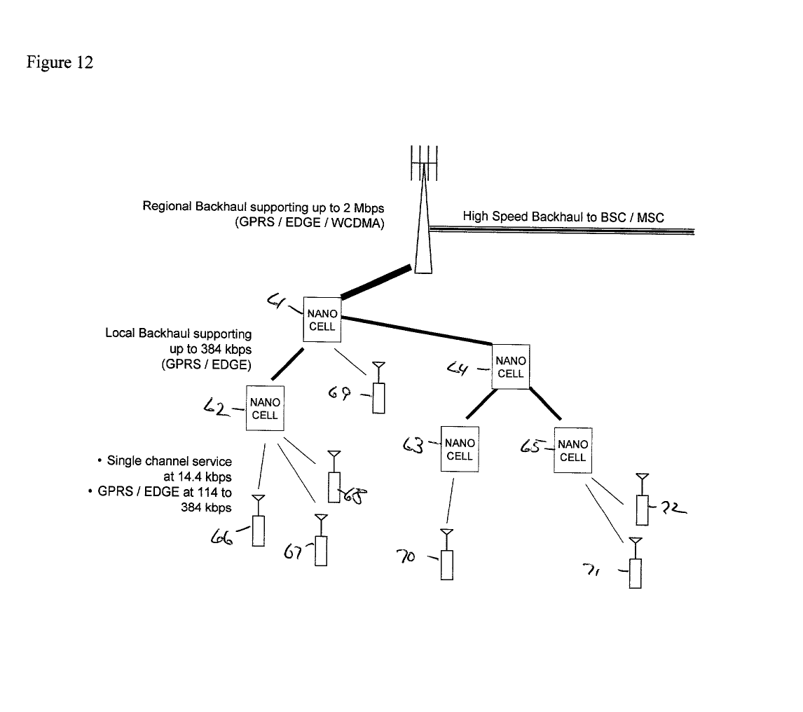

FIG. 12 displays an example of a hierarchical infrastructure of the present invention. There is shown in this Figure, a BTS 60 and a plurality of nanoCell base stations 61, 62, 63, 64, 65. The nanoCell base stations are in turn in communication with a plurality of mobile stations or other wireless apparatus 66, 67, 68, 69, 70, 71. In this example the communications channel may be General Packet Radio Service (GPRS), EDGE, or other recently defined communication systems such as Wideband CDMA (WCDMA) and cdma2000. In this example the backhaul speed between the BTS and the individual nanoCell base stations is on the order up to about 2 Mbps. Local backhaul between two nanoCell base stations is on the order of up to about 384 kbps or more. For the backhaul between a wireless device and a nanoCell base station the backhaul can be in the order of about 14.4 kbps and higher. When GPRS or EDGE is used the backhaul range is 114 to about 384 kbps.

The preferred method of implementing a nanoCell base station is to use software defined radio methods. The software defined radio enables several improvements over traditional radios: short development cycle due to ability to reprogram the radio to meet different protocols, ability to upgrade radio with latest revisions of standards without the need to physically access unit, and ability to dynamically reconfigure radio to support different protocols as a function of load requirements, eg, high data rate concentrator hub running 384 kbps EDGE protocol to backhaul multiple 56 kbps GPRS channels for different users.

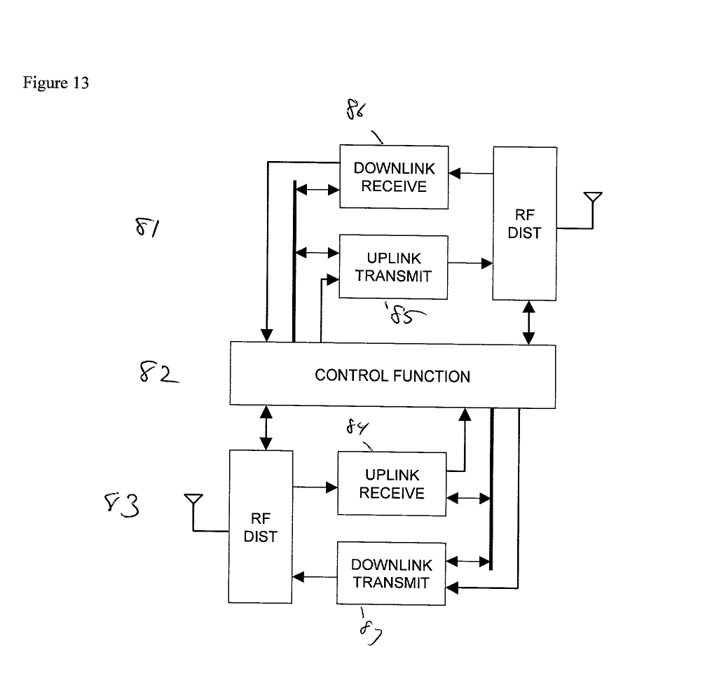

The nanoCell base station is typically divided in its construction in view of the different types of operations that it performs. As seen in FIG. 13 the portion 81 of the nanoCell base station operates similar to that of a conventional mobile station. The mobile station portion 81 allocates frequency, time slot and code channel in a manner similar to the way a mobile station performs these functions. Control channel selection is based upon a survey conducted by the downlink receive function to detect and identify the best available downlink channel and channel selection is authorized through the configuration and control link. Synchronization, timing and frequency stabilization is attained through measurements made on this interface. The configuration and control of the nanoCell base station is managed over this interface wherein command and control messages are received on the downlink channel and provided to the control function 82 for further disposition. The nanoCell base station is also provided with a base station portion 83 that is similar in function to a base transceiver station. The base station portion allocates the frequency, the time slot and the code channel in the same manner as the base transceiver station would. This interface acts as the radio interface to mobile stations or other downstream nanoCell base stations. Control channel allocation is based on a survey conducted by the mobile station portion 81 as prioritized by an internal selection list and authorized through the configuration and control link. Configuration and control of the downstream nanoCell base stations is achieved by transmitting command and control messages to them. In order to minimize latency of direct transfers through the nanoCell base station, it is possible to connect the uplink receive path 84 directly with the uplink transmit path 85 and the downlink receive path 86 directly with the downlink transmit path 87 so long as an appropriate frequency, time slot or code channel conversion is accommodated.

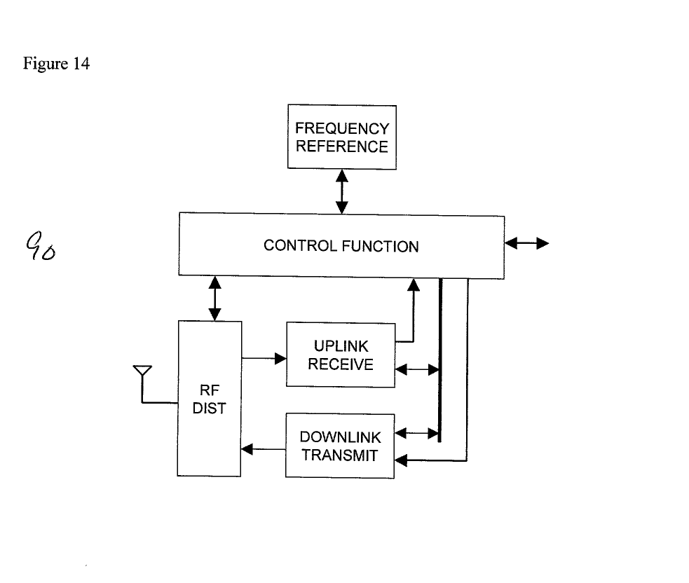

In another embodiment of the nanoCell, a representative primary base station 90 is shown in FIG. 14. The primary base station subsystem 91 provides the principle interface between the base station controller and the radio network. Synchronization, timing and frequency reference 92 is established within this subsystem. Commands from the base station controller interface are used to configure and control the primary base station to establish control channels frequency allocation and code channels. Control channel selection is based upon reported results from downstream nanoCell base stations and authorized through the base station controller interface. Data from this interface is modulated for transmission on the down link radio interface. Signals received on the uplink radio interface are demodulated and provided to the base station controlled interface. This is the primary base station radio interface to mobile stations and other downstream nanoCell base stations. Frequency, time slot and code channel allocation are base on commands received through the base station controller interface. The configuration and control of downstream nanoCell base stations is accomplished by transmitting command and control messages to them.

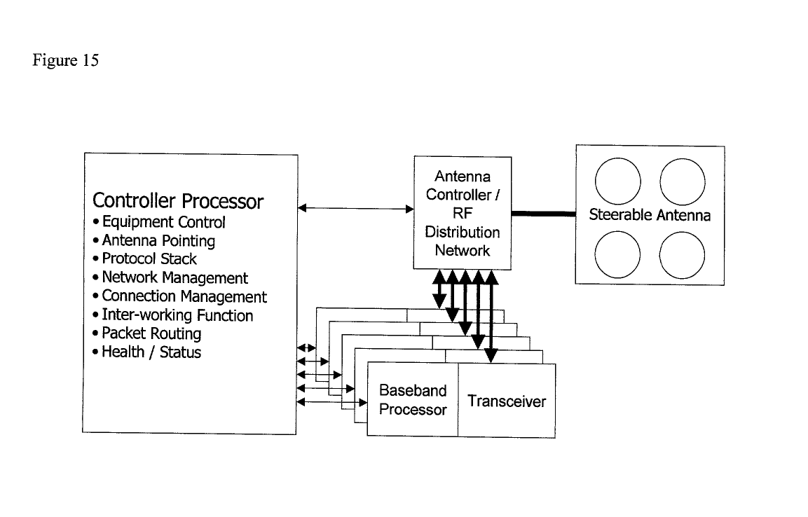

The software defined radio modules are represented in FIG. 15. The modules are over-the-air programmable and support multiple waveforms. The modules are preferably configurable as user nodes or as service backhaul and operate as a mobile station or a BTS. A steerable antenna array is used by the modules. The antenna preferably has high gain in the direction of adjacent nodes and enables interference avoidance. A preferred antenna is a beamforming antenna. The control processor controls network management and control management as well as the protocol stack and the inter-working function. In addition, the control processor also controls packet routing, equipment control, antenna pointing and monitors the health/status of the system.

The control processor controls the equipment, manages the network as well as performs frequency stability management. The control processor also performs layer 3 protocol processing and has an intercommunication function. The control processor of the nanoCell base station typically contains the information required to control the interaction between the user and the network. The control processor in the system governs control and queuing, routing and the data links between the user and the BTS.

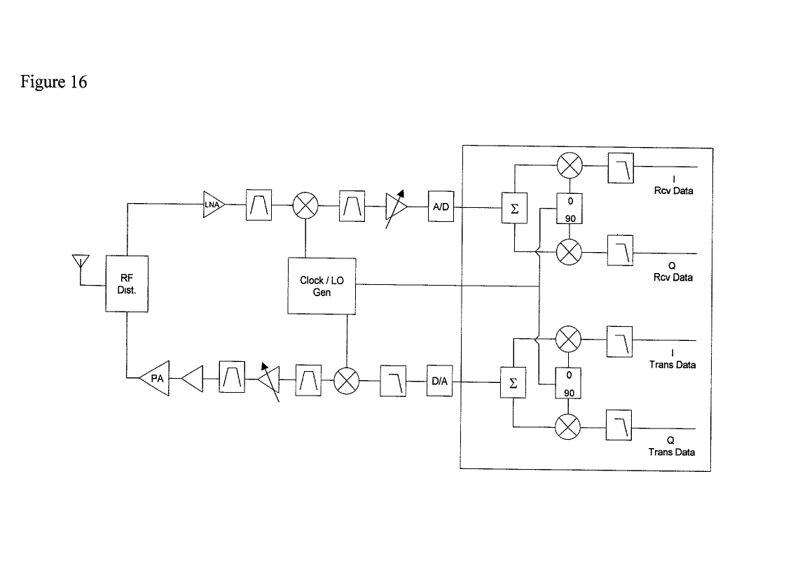

FIG. 16 is the nanoCell RF Transceiver block diagram showing the relation of the receivers and transmitters in the nanoCell to the base band processor. As shown in this figure, the characteristics of the nanoCell base station preferably includes a radio frequency in the range of 824 to 3600 MHZ, as well as simultaneous Tx/Rx. The converter in this base station is preferably tunable over the entire frequency range as well as controlling selectivity filtering, isolation of the signal and output power amplifier (PA). The RF module provides up and down conversion and filtering of RF signals to support BTS and MS functions of the nanoCell base station.

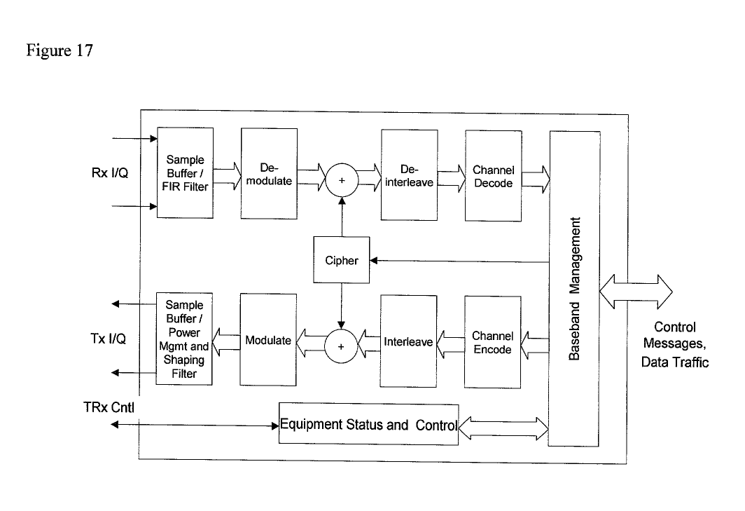

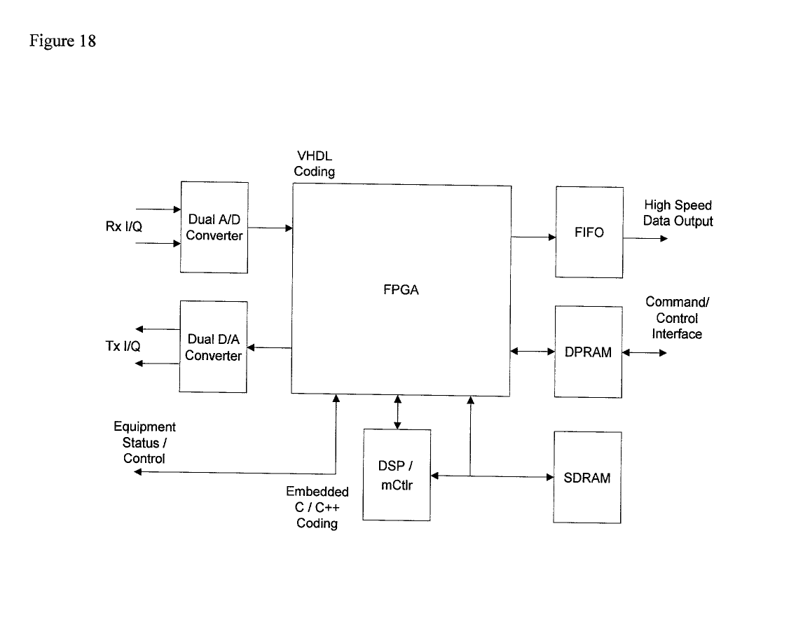

FIG. 17 shows one embodiment of the operation of the baseband processor of FIG. 15. The purpose of the baseband processor is to provide digital modulation and demodulation functions within the nanoCell base station. FIG. 18 shows the preferred details of the structure of the baseband processor. The base band processor controls the transceiver, performs digital filtering and equalization performs layer 1 processing control and layer 2 control. The baseband processor can operate either by IF or the baseband sampling.

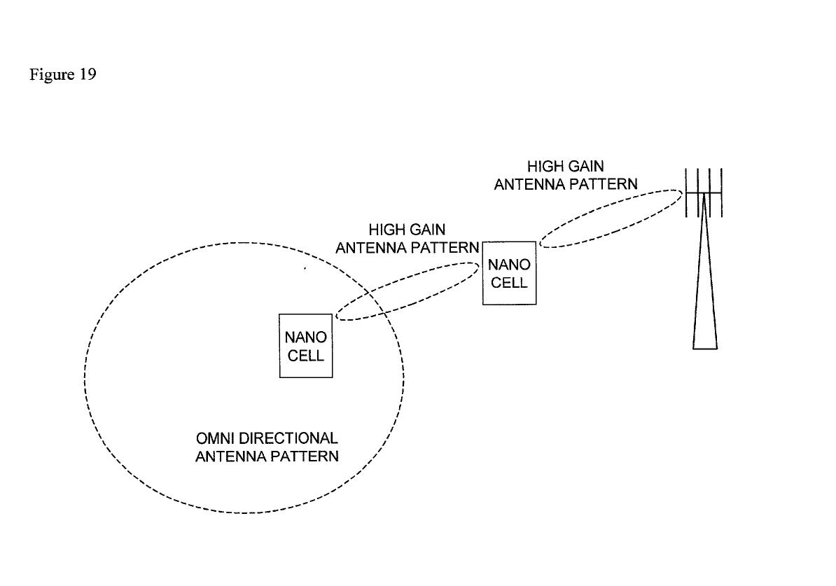

The purpose of a steerable antenna array is to increase directivity or gain in the direction of a base transceiver station or an adjacent nanoCell, as shown in FIG. 19. By increasing gain, the carrier to interference ratio—C/I—is increased, thus improving link performance. Greater C/I translates directly to increased data rate and frequency reuse distance. Because nanoCells are stationary, the complexity of steerable antenna arrays is significantly reduced making the overall unit less expensive to build. This is in comparison to a dynamically steered array that strives to maintain a beam pointed at a mobile station. The technical complexity and algorithmic complexity of that requirement makes a cost effective array cost prohibitive for a nanoCell. A less complex array used in a stationary nanoCell environment is significantly more cost effective.

As seen in FIG. 19 adaptive beam steering homes in on the beacon frequency of adjacent nodes so gain is optimized for a high data rate. Directional beam linking of adjacent nodes is used to improve C/I and therefore provide higher data rates for backhaul. The omnidirectional pattern is presented to local end users to provide appropriate coverage and Quality of Service (QoS). One advantage of the present invention is that it reduces the frequency planning and topography analysis. In addition, it automatically compensates for interference and blockage. A phased array antenna is preferred for backhaul as they can have a simple steer-on-beacon algorithm which will support higher data rates.

We claim:

1. A nanoCell base station for providing radio connectivity among one or more mobile stations, one or more base transceiver stations or one or more other nanoCell base stations comprising one or more transceivers, one of said transceivers providing a base station function, and one of said transceivers providing a mobile station function, and a controller for managing the transceivers, and determining the communications connectivity paths between base station and mobile station functions.

2. The nanoCell base station according to claim 1 wherein one transceiver provides both a base station and mobile station function.

3. The nanoCell base station according to claim 1 wherein one of said transceivers provides a base station function, and another of said transceivers provides a mobile station function.

4. The nanoCell base station according to claim 1 wherein the nanoCell base station functions as a relay.

5. The nanoCell base station according to claim 1 wherein the nanoCell base station functions as a collector.

6. The nanoCell base station according to claim 1 wherein the nanoCell base station functions as a concentrator.

7. The nanoCell base station according to claim 1 wherein the nanoCell base station functions as a delay node.

8. The nanoCell base station according to claim 1 wherein the nanoCell base station is adapted to function as a relay, a collector, a concentrator or a delay node in order to provide efficient connectivity between mobile and base transceiver stations.

9. The nanoCell base station according to claim 1 being adapted to use in-band back haul to communicate with one or more other nanoCell base stations having low traffic concentrations in the event that the concentration of traffic is such that there is insufficient capacity between the nanoCell base station and a macro cell BTS.

10. The nanoCell base station according to claim 1 comprising a communication transceiver that is adapted to function as either a BTS, a MS or a relay.

11. The nanoCell base station according to claim 10 wherein said transceiver when functioning as a BTS, transmits on a downlink channel and receives on an uplink channel as would a base station.

12. The nanoCell base station according to claim 10 wherein said transceiver when functioning as a MS transmits on an uplink channel and receives on a downlink channel as would a MS.

13. The nanoCell base station according to claim 10 wherein said transceiver when functioning as a relay, transmits and receives on independent channels, either of which may be uplink or downlink channels.

14. The nanoCell base station according to claim 13 wherein said transceiver when functioning as a relay has a channel configured as an uplink receiver and uplink transmitter.

15. The nanoCell base station according to claim 13 wherein said transceiver when functioning as a relay has a downlink receiver and downlink transmitter.

16. The nanoCell base station according to claim 13 wherein said transceiver when functioning as a relay is configured as an uplink receiver and a downlink transmitter.

17. The nanoCell base station according to claim 13 wherein said transceiver when functioning as a relay is configured as a downlink receiver and an uplink transmitter.

18. The nanoCell base station according to claim 5 wherein said base station is adapted to reroute multiple individual channels without modifying the data stream within an incoming/outgoing channel.

19. The nanoCell base station according to claim 16 wherein for a given channel defined by a center frequency (f), a channel identifier (c), a data rate (r), and power level (p), said channel is converted without modification of the data stream to a secondary frequency and channel number that is multiplexed with other individual channels.

20. The nanoCell base station according to claim 19 wherein said base station when functioning as a collector takes a given channel defined by a center frequency (f), a channel identifier (c), a data rate (r), and power level (p), and re-multiplexes these into a new channel without modification of the channel structure such that “f” and “c” are changed without changing “r”.

21. The nanoCell base station according to claim 6 wherein said base station when functioning as a concentrator causes a data rate conversion and concentration of multiple independent channels into a new, higher rate channel.

22. The nanoCell base station according to claim 6 wherein said base station when functioning as a concentrator causes separation of a concentrated high rate channel into its constituent lower rate independent channels.

23. The nanoCell base station according to claim 6 wherein said base station when functioning as a concentrator causes a single channel to convert into a higher rate channel.

24. The nanoCell base station according to claim 6 wherein said base station when functioning as a concentrator causes a higher rate channel to convert into a single channel.

25. The nanoCell base station according to claim 4 wherein said base station when functioning as a relay translates an individual channel between the incoming and outgoing channels without modification of the data stream or the multiplexing structure.

26. The nanoCell base station according to claim 7 wherein said base station when functioning as a delay receives and holds data until such time as an appropriate outgoing channel is available.

27. The nanoCell base station according to claim 7 wherein said base station when functioning as a delay gives higher priority communications a preference for use of nanoCell transceiver resources while a lower priority communication is temporarily delayed.

28. The nanoCell base station according to claim 27 wherein the delay is fixed.

29. The nanoCell base station according to claim 27 wherein the delay is variable.

30. The nanoCell base station according to claim 1 wherein a communications channel that is predominantly meant to traverse a FDD network from a BTS to a mobile station, via a downlink channel is translated by two or more nanoCells in a non-standard manner to make most efficient use of underused spectra.

31. The nanoCell base station according to claim 1 wherein a communications channel that is predominantly meant to traverse from a mobile station to a fixed site via an uplink channel is translated by two or more nanoCells in a non-standard manner to make most efficient use of underused spectra.

32. An intercommunicating network of nanoCell base stations according to claim 1 adapted to dynamically determine efficient communication paths based on service prioritization, network loading and node availability.

33. The nanoCell base station according to claim 32 wherein subsequent communications are capable of being routed via different paths in order to distribute traffic loading.

34. The nanoCell base station according to claim 33 wherein communications within a nanoCell network can be redistributed away from or toward a particular BTS in order to more efficiently accommodate mobile stations with varying quality of service requirements.

35. A method of configuring traffic loads in a network comprising
synchronizing a first nanoCell to a beacon channel and establishing its local frequency and timing reference;
registering said first nanoCell with a BTS as a mobile station (MS);
broadcasting said first nanoCell as a BTS on an alternative beacon channel;
synching a second nanoCell to said first node's beacon channel and establishing the frequency and timing reference;
registering said second nanoCell with said first node as an MS;
broadcasting said second nanoCell as a BTS on an alternative beacon channel;
synchronizing a user MS to said second nanoCell's beacon channel and establishing its local frequency and timing reference;
registering the user MS with said second nanoCell;
establishing a circuit or packet connection with said second nanoCell once the user registers with said second nanoCell and, the user requests service;
establishing appropriate connections between said second nanoCell, said first nanoCell and said BTS;
establishing a connection between said BTS and an MSC for billing purposes.

36. A method of synchronization and channel allocation in a communications network comprising
a first nanoCell receiving a beacon channel f1 and f2 from a BTS b1 and b2, respectively, and synchronizing to each individually;
said first nanoCell selecting beacon channel f3 to transmit;
at least a second nanoCell receiving frequencies f1, f2 and f3, and synchronizing to each individually;
said additional nanoCells selecting beacon channels f4 and f5 respectively to transmit.

37. A method of configuring traffic loads in a network according to claim 35 wherein network connectivity is configured in a concatenated series of arbitrary number of nanoCells.

38. A method of configuring traffic loads in a network according to claim 35 wherein network connectivity is configured in a matrix fashion for an arbitrary number of nanoCells.

39. A method of configuring traffic loads in a network according to claim 35 wherein network connectivity is configured for a combination of concatenated nanoCells and nanoCell matrices.

40. A method of synchronization and channel allocation in a communications network according to claim 36 wherein network connectivity is configured in a concatenated series of arbitrary number of nanoCells.

41. A method of synchronization and channel allocation in a communications network according to claim 36 wherein network connectivity is configured in a matrix fashion for an arbitrary number of nanoCells.

42. A method of synchronization and channel allocation in a communications network according to claim 36 wherein network connectivity is configured for a combination of concatenated nanoCells and nanoCell matrices.

43. The method according to claim 36 wherein if synchronization is established between two nanoCells, additional synchronization is dismissed.

44. The method according to claim 43 wherein if any link is lost between any nanoCell, re-selection of a new beacon channel occurs, and re-synchronization is used to establish new connectivity within the network.

45. The method according to claim 44 wherein a nanoCell establishes the requisite accuracy in its internal frequency reference based upon the transmitted accuracy of adjacent base stations or adjacent nanoCells.

46. An intercommunicating network of nanoCell base stations according to claim 9 wherein the backhaul speed between a BTS and an individual nanoCell base station is on the order up to about 2 Mbps.

47. An intercommunicating network of nanoCell base stations according to claim 9 wherein the backhaul speed between two nanoCell base stations is on the order of up to about 384 kbps or more.

48. An intercommunicating network of nanoCell base stations according to claim 9 wherein the backhaul speed is in the order of about 4.8 kbps and higher.

49. An intercommunicating network of nanoCell base stations according to claim 9 wherein the backhaul speed when a GPRS is used is up to about 114 kbps.

50. An intercommunicating network of nanoCell base stations according to claim 9 wherein the backhaul speed when an EDGE is used is up to about 384 kbps.

51. A network of nanoCell base stations comprising two or more nanoCell base stations of claim 1.

52. A nanoCell base station comprising
a base station portion adapted to communicate with one or more mobile stations or with one or more other nanoCell base stations; and
a mobile station portion adapted to communicate with one or more other nanoCell base stations, with one or more base transceiver stations, or one or more primary base stations.
